(19) United States
(12) Patent Application Publication
(10) Pub. No.: US 2025/0266461 A1
(43) Pub. Date: Aug. 21, 2025

(54) ELECTRODE MIXTURE AND BATTERY

(71) Applicant: TOYOTA JIDOSHA KABUSHIKI KAISHA, Aichi-ken (JP)

(72) Inventors: Hideyuki YAMAMURA, Susono-shi (JP); Hiroshi SUYAMA, Mishima-shi (JP)

(21) Appl. No.: 19/053,422

(22) Filed: Feb. 14, 2025

(30) Foreign Application Priority Data
Feb. 21, 2024 (JP) 2024-024404

(51) Int. Cl. H01M 4/62; H01M 4/02; H01M 4/133; H01M 4/587; H01M 10/054

(52) U.S. Cl. CPC H01M 4/624; H01M 4/133; H01M 4/587; H01M 10/054; H01M 2004/027

(57) ABSTRACT

An object of the present disclosure is to provide an electrode mixture that can improve battery capacity, and a battery comprising the electrode mixture. The electrode mixture of the disclosure comprises hard carbon. The electrode mixture of the disclosure comprises a metal oxide. The metal element constituting the metal oxide is a period 4 d-block element, and the ratio of the mass of the metal oxide with respect to the total mass of the hard carbon and metal oxide is less than 10 mass %. The battery of the disclosure comprises a negative electrode collector layer, negative electrode active material layer, electrolyte layer, positive electrode active material layer and positive electrode collector layer in that order, and either the negative electrode active material layer or the positive electrode active material layer comprises an electrode mixture of the disclosure.

### FIELD

The present disclosure relates to an electrode mixture and a battery.

### BACKGROUND

Lithium ion batteries are used as power sources for mobile devices and on-vehicle devices, taking advantage of their characteristics such as high capacity and light weight. In recent years, sodium ion batteries using sodium as materials instead of lithium are attracting interest from the viewpoint of resource conservation.

Techniques have been developed for utilizing hard carbon as a negative electrode active material in a secondary battery such as a lithium ion battery or sodium ion battery, as disclosed in PTL 1.

### CITATION LIST

### Patent Literature

[PTL 1] Japanese Unexamined Patent Publication No. 2017-050148

### SUMMARY

### Technical Problem

There remains room for improvement in the battery capacities of batteries that utilize hard carbon as the negative electrode active material.

It is an object of the present disclosure to provide an electrode mixture that can improve battery capacity, and a battery comprising the electrode mixture.

### Solution to Problem

The present inventors have found that this object can be achieved by the following means.

### Aspect 1

An electrode mixture comprising hard carbon,
wherein the electrode mixture comprises a metal oxide,
wherein the metal element constituting the metal oxide is a period 4 d-block element, and
wherein the ratio of the mass of the metal oxide with respect to the total mass of the hard carbon and metal oxide is less than 10 mass %.

### Aspect 2

The electrode mixture according to aspect 1, wherein the metal oxide includes at least one element from among iron, titanium, manganese, zinc, nickel and copper.

### Aspect 3

The electrode mixture according to aspect 2, wherein the metal oxide is Fe₂O₃, TiO, TiO₂, MnO, Mn₂O₃, MnO₂, NiO, CuO or ZnO.

### Aspect 4

The electrode mixture according to aspect 2, wherein the metal oxide includes at least one element from among iron, titanium and manganese.

### Aspect 5

The electrode mixture according to aspect 2, wherein the metal oxide is Fe₂O₃, TiO, TiO₂, MnO, Mn₂O₃ or MnO₂.

### Aspect 6

The electrode mixture according to aspect 5, wherein the metal oxide is Fe₂O₃, TiO, MnO or Mn₂O₃.

### Aspect 7

The electrode mixture according to aspect 4, wherein the metal oxide includes the element iron.

### Aspect 8

The electrode mixture according to aspect 7, wherein the metal oxide is Fe₂O₃.

### Aspect 9

A battery, comprising:
a negative electrode collector layer, a negative electrode active material layer, an electrolyte layer, a positive electrode active material layer and a positive electrode collector layer in that order, and
wherein either the negative electrode active material layer or the positive electrode active material layer comprises an electrode mixture according to any one of aspects 1 to 8.

### Aspect 10

The battery according to aspect 9, wherein the negative electrode active material layer comprises an electrode mixture according to any one of aspects 1 to 8.

### Aspect 11

The battery according to aspect 10, wherein the battery is a sodium ion battery with the electrolyte layer comprising sodium ion.

### Advantageous Effects of Invention

According to the disclosure it is possible to provide an electrode mixture that can improve battery capacity, and a battery comprising the electrode mixture.

### BRIEF DESCRIPTION OF DRAWINGS

FIG. 1 is a simplified cross-sectional view showing an example of a battery of the disclosure.

### DESCRIPTION OF EMBODIMENTS

An embodiment of the disclosure will now be described in detail. However, it should be noted that the disclosure is not limited to the embodiment described below, and thus various modifications may be implemented which do not depart from the gist thereof.

### ELECTRODE MIXTURE

### Electrode Mixture

The electrode mixture of the disclosure comprises hard carbon. The electrode mixture of the disclosure comprises a metal oxide. The metal element constituting the metal oxide is a period 4 d-block element, and the ratio of the mass of the metal oxide with respect to the total mass of the hard carbon and metal oxide is less than 10 mass %.

The present inventors have found, unexpectedly, that an electrode mixture comprising hard carbon and a predetermined amount of a metal oxide composed of a metal element which is a period 4 d-block element, can improve the battery capacity of a battery which comprises the electrode mixture. Without being restricted to any particular theory, the reason for this is conjectured to be as follows. Specifically, a metal oxide composed of a metal element which is a period 4 d-block element has relatively high conductivity. It is thought that if the electrode mixture comprises a predetermined amount of such a metal oxide, then the electron conductivity of the battery is affected, resulting in improved battery capacity.

For the purpose of the disclosure, “electrode mixture” means a composition that can form an electrode active material layer either by itself or by further comprising other components. Moreover, the term “electrode mixture slurry” means a slurry that includes a dispersing medium in addition to the “electrode mixture”, allowing it to form an electrode active material layer by being coated and dried.

The electrode mixture of the disclosure comprises hard carbon. The electrode mixture of the disclosure comprises a metal oxide composed of a metal element which is a period 4 d-block element. The electrode mixture of the disclosure may also optionally include a conductive aid and a binder. When the battery comprising the electrode mixture of the disclosure is a solid-state battery, the electrode mixture of the disclosure may also optionally include a solid electrolyte.

### Hard Carbon

The electrode mixture of the disclosure comprises hard carbon. The hard carbon can function as an electrode active material.

The term “electrode active material” may be used to mean “positive electrode active material” or “negative electrode active material”, and especially “negative electrode active material”.

The hard carbon content may be 50 mass % or greater, 70 mass % or greater, 80 mass % or greater, 90 mass % or greater or 95 mass % or greater, and less than 100 mass %, 99 mass % or less, 95 mass % or less or 90 mass % or less.

The mean particle diameter of the hard carbon is not particularly limited, and may be 50 nm to 100 μm, for example.

The hard carbon used may be a commercial product, produced by a common method. The hard carbon may be produced by carbonization of a starting material containing carbon, for example. A carbonization temperature of 1000 to 2000° C., for example, is suitable. The carbonization may be carried out under an inert atmosphere. The starting material for the hard carbon is not particularly limited, so long as it is a material that can produce hard carbon. It may be a starting material of an organic compound, for example, an alcohol such as ethanol, a phenol, or an aldehyde such as formaldehyde. The starting material used may also be a resin such as a phenol resin or a polyacrylonitrile or polyimide resin. These starting materials may be used alone, or two or more may be used in admixture.

### Metal Oxide

The electrode mixture of the disclosure comprises a metal oxide. The metal element constituting the metal oxide is a period 4 d-block clement. The ratio of the mass of the metal oxide with respect to the total mass of the hard carbon and metal oxide is less than 10 mass %. Such a construction can improve the battery capacity, and especially the discharge capacity.

The metal element of the period 4 d-block element may be iron, titanium, manganese element, nickel element, copper, zinc, scandium, vanadium or chromium. The metal oxide composed of such a metal element may be FeO, Fe₃O₄, Fe₂O₃, TiO, TiO₂, MnO, Mn₃O₄, Mn₂O₃, MnO₂, MnO₃, Mn₂O₇, NiO, NiO₂, Ni₂O₃, Cu₂O, CuO, ZnO, Sc₂O₃, VO, V₂O₃, VO₂, V₂O₅, CrO, Cr₂O₃, CrO₂ or CrO₃, for example.

The metal oxide preferably includes at least one from among iron, titanium, manganese, nickel, copper and zinc. The metal oxide may also include one of these elements. More specifically, the metal oxide may include iron, titanium, manganese, nickel, copper or zinc. In this case the metal oxide may be Fe₂O₃, TiO, TiO₂, MnO, Mn₂O₃, MnO₂, NiO, CuO or ZnO.

The metal oxide more preferably includes at least one from among iron, titanium and manganese. The metal oxide may also include any one of these elements. More particularly, the metal oxide may include iron, titanium or manganese. In this case the metal oxide may be Fe₂O₃, TiO, TiO₂, MnO, Mn₂O₃ or MnO₂. With such a construction, it is possible to improve not only the battery capacity but also the battery charge-discharge efficiency, given a standard C rate for a secondary battery (for example, 0.3 C). For the purpose of the disclosure, the charge-discharge efficiency is the ratio of the discharge capacity with respect to the charge capacity. From the viewpoint of more effectively improving the battery capacity and charge-discharge efficiency, the metal oxide is more preferably Fe₂O₃, TiO, MnO or Mn₂O₃.

If the metal oxide includes titanium or manganese, and especially if the metal oxide is TiO, TiO₂, MnO or MnO₂, it will be possible to improve the charge-discharge efficiency of a battery at a C rate (such as 0.1 C) which is lower than the standard C rate for a secondary battery.

The metal oxide may include iron, from the viewpoint of effectively improving not only the battery capacity but also the battery capacity retention. In this case, the metal oxide may be Fe₂O₃. For the purpose of the disclosure, the capacity retention is the ratio of the discharge capacity at a standard C rate for a secondary battery (such as 0.3 C), with respect to the discharge capacity at a lower C rate (such as 0.1 C).

The ratio of the mass of the metal oxide with respect to the total mass of the hard carbon and metal oxide is lower than 10 mass %. The ratio may be 0.1 mass % or greater, 0.5 mass % or greater, 1 mass % or greater, 1.5 mass % or greater, 2 mass % or greater, 3 mass % or greater or 4 mass %, and 9 mass % or less, 8 mass % or less, 7 mass % or less, 6 mass % or less, 5 mass % or less, 4 mass % or less or 3 mass % or less.

### Conductive Aid

The conductive aid may be a carbon material or metal material, for example. Specific examples of carbon materials include carbon blacks such as acetylene black, Ketjen black, furnace black and thermal black; carbon fibers such as VGCF; graphite; hard carbon; and coke. The metal material may be Fe, Cu, Ni or Al. These may be used alone, or two or more may be used in admixture. The content of the conductive aid in the electrode mixture is not particularly limited, and may be set as appropriate for the desired conductivity.

### Binder

The binder used may be one which is chemically and electrically stable. Specific examples of binders include fluorine-based binders such as polyvinylidene fluoride (PVdF) binders and polytetrafluoroethylene (PTFE) binders; rubber-based binders such as styrene-butadiene rubber (SBR) binders; olefin-based binders such as polypropylene (PP) binders and polyethylene (PE) binders; cellulose-based binders such as carboxymethyl cellulose (CMC) binders; and polyacrylic acid (PAA) binders. These may be used alone, or two or more may be used in admixture. The content of the binder in the electrode mixture is not particularly limited, and may be set as appropriate for the desired bondability.

### Solid Electrolyte

The solid electrolyte may be an inorganic solid electrolyte. Examples of inorganic solid electrolytes include solid oxide electrolytes and solid sulfide electrolytes. Examples of solid oxide electrolytes include NASION-based compounds such as Na₃Zr₂Si₂PO₁₂, and β-alumina (Na₂O-11Al₂O₃). An example of a solid sulfide electrolyte is Na₂S—P₂S₅. The solid electrolyte may be in particulate form, for example.

### Other Components

The electrode mixture of the disclosure may also include an electrode active material other than hard carbon. The content of a negative electrode active material other than hard carbon may be less than 50 mass %, less than 30 mass %, less than 10 mass %, less than 5 mass % or less than 1 mass %. The electrode mixture of the disclosure may also include additives other than the aforementioned conductive aids, binders and solid electrolytes.

The method for preparing the electrode mixture of the disclosure may be a method of mixing an electrode active material and optionally a solid electrolyte, conductive aid and binder. The components may be mixed together with a dispersing medium to prepare an electrode mixture slurry.

### Battery

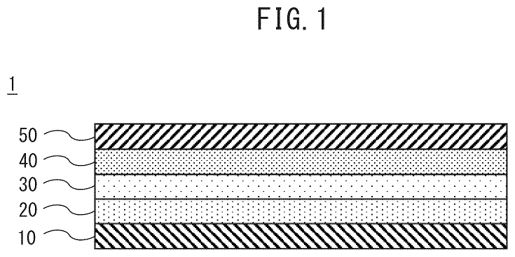

As shown in FIG. 1, the battery 1 of the disclosure comprises a negative electrode collector layer 10, negative electrode active material layer 20, electrolyte layer 30, positive electrode active material layer 40 and positive electrode collector layer 50 in that order, and either the negative electrode active material layer or the positive electrode active material layer comprises an electrode mixture of the disclosure.

The battery of the disclosure may be a primary battery, or a secondary battery such as a lithium ion battery or sodium ion battery. The battery of the disclosure may be a sodium ion battery wherein the electrolyte layer comprises sodium ion.

The battery of the disclosure may also be a liquid battery or a solid-state battery. The term “solid-state battery” as used herein refers to a battery using at least a solid electrolyte as the electrolyte, and the solid-state battery may employ a combination of a solid electrolyte and a liquid electrolyte as the electrolyte. The solid-state battery of the disclosure may also be an all-solid-state battery, i.e. a battery employing only a solid electrolyte as the electrolyte.

The elements of the battery of the disclosure will now be explained using an example where the battery of the disclosure is a sodium ion battery.

### Negative Electrode Collector Layer

Examples of materials for the negative electrode collector layer include SUS, aluminum, copper, nickel and carbon.

The negative electrode collector layer may be in a foil, mesh or porous form, for example.

### Negative Electrode Active Material Layer

The negative electrode active material layer comprises a negative electrode mixture that includes a negative electrode active material, and optionally a solid electrolyte, a conductive aid and a binder. Specifically, the negative electrode mixture may be an electrode mixture of the disclosure. In other words, the negative electrode active material layer may comprise an electrode mixture of the disclosure. The electrode mixture of the disclosure will be understood by referring to the aforementioned description of the electrode mixture of the disclosure.

The negative electrode active material layer may have a fixed thickness. The thickness of the negative electrode active material layer is not particularly limited, and may be 0.1 μm to 1 mm, for example.

### Electrolyte Layer

When the battery of the disclosure is a liquid battery, the electrolyte layer may be formed by impregnating a separator with the electrolyte solution.

### (Separator)

The material for the separator is not particularly limited, so long as it has a function of electrically separating the negative electrode active material layer and the positive electrode active material layer, and examples include porous insulating materials, which may be porous sheets made of resins such as polyethylene (PE), polypropylene (PP), polyester, cellulose and polyamide, or nonwoven fabrics or glass fiber nonwoven fabrics, or combinations of the foregoing. The thickness of the separator is not particularly limited, and may be 5 μm to 1 mm, for example.

### (Electrolyte Solution)

The electrolyte solution may comprise a sodium salt and a non-aqueous solvent. Examples of sodium salts include inorganic sodium salts such as NaPF₆, NaBF₄, NaClO₄ and NaAsF₆; and organic sodium salts such as NaCF₃SO₃, NaN(CF₃SO₂)₂, NaN(C₂F₅SO₂)₂, NaN(FSO₂)₂ and NaC(CF₃SO₂)₃.

A non-aqueous solvent is not particularly limited, so long as it can dissolve sodium salts. Non-aqueous solvents include high-permittivity solvents and low-permittivity solvents. Examples of high-permittivity solvents include cyclic esters (cyclic carbonates) such as ethylene carbonate (EC), propylene carbonate (PC) and butylene carbonate (BC), and γ-butyrolactone, sulfolane, N-methyl-2-pyrrolidone (NMP) and 1,3-dimethyl-2-imidazolidinone (DMI). Examples of low-viscosity solvents include straight-chain esters (straight-chain carbonates) such as dimethyl carbonate (DMC), diethyl carbonate (DEC) and ethylmethyl carbonate (EMC), acetates such as methyl acetate and ethyl acetate, and ethers such as 2-methyltetrahydrofuran. A mixed solvent comprising a mixture of a high-permittivity solvent and a low-viscosity solvent may also be used.

When the battery of the disclosure is a solid-state battery, the electrolyte layer comprises a solid electrolyte, and may also optionally comprise a conductive aid and a binder.

The solid electrolyte, conductive aid and binder may be understood by referring to the aforementioned description regarding the electrode mixture of the disclosure.

### Positive Electrode Active Material Layer

The positive electrode active material layer comprises a positive electrode active material, and may also optionally comprise a conductive aid and a binder. When the battery of the disclosure is a solid-state battery, the positive electrode active material layer may also optionally comprise a solid electrolyte.

When the negative electrode active material layer comprises an electrode mixture of the disclosure, i.e. when hard carbon is used as a negative electrode active material, the positive electrode active material used may be a substance exhibiting an electropositive potential for the negative electrode active material. Examples of such positive electrode active materials include Na-containing oxides such as laminar active materials, spinel active materials and olivine-type active materials. Specific materials include NaFeO₂, NaNiO₂, NaCoO₂, NaMnO₂, NaVO₂, Na(Ni_{X}Mn_{1-X})O₂ (0<X<1), Na(Fe_{X}Mn_{1-X})O₂ (0<X<1), NaVPO₄F, Na₂FePO₄F and Na₃V₂(PO₄)₃.

The positive electrode active material content may be 50 mass % or greater, 70 mass % or greater, 80 mass % or greater, 90 mass % or greater or 95 mass % or greater, and less than 100 mass %, 99 mass % or less, 95 mass % or less or 90 mass % or less.

The form of the positive electrode active material is not particularly limited, and may be particulate, for example. The mean particle diameter in this case may be 1 nm or larger or 10 nm or larger, and 100 μm or smaller or 30 μm or smaller, for example.

The conductive aid, binder and solid electrolyte may be understood by referring to the aforementioned description regarding the electrode mixture of the disclosure.

The positive electrode active material layer may have a fixed thickness. The thickness of the positive electrode active material layer is not particularly limited, and may be 0.1 μm to 1 mm, for example.

### Positive Electrode Collector Layer

Examples of materials for the positive electrode collector layer include SUS, aluminum, nickel, iron, titanium and carbon.

The positive electrode collector layer may be in a foil, mesh or porous form, for example.

When the battery of the disclosure is a battery other than a sodium ion battery, for example, various materials commonly employed in such batteries may be used.

### Remaining Construction

The battery of the disclosure may be provided with a battery case which houses the layers of the battery, and terminals connected to the current collectors. The battery of the disclosure may also be provided with a restraining member restraining each layer along the stacking direction, in order to reduce contact resistance. Such a member may be any type of conventional one.

Examples of types of the battery of the disclosure include coin, laminated, cylindrical and rectilinear battery types.

The method for producing the battery of the disclosure may include forming an electrode active material layer comprising the electrode mixture of the disclosure.

The method of forming the electrode active material layer may be a wet method or a dry method.

A wet method for forming the electrode active material layer may include providing an electrode mixture slurry that comprises the electrode mixture of the disclosure and a dispersing medium, and coating the electrode mixture slurry onto a substrate and then drying and removing the dispersing medium.

The dispersing medium is not particularly limited, and may be an alcohol, glycol, cellosolve, amine, ketone, amide carboxylate, amide phosphate, sulfoxide, carboxylic acid ester, phosphoric acid ester, ether or nitrile. Specific examples include ethanol, 2-propanol, methyl ethyl ketone and N-2-methylpyrrolidone.

The drying temperature and drying time may be appropriately set, depending on the boiling point and amount of the dispersing medium.

A dry method for forming the electrode active material layer may include forming a green compact of the electrode mixture on a substrate.

The electrode mixture used in the method of forming the electrode active material layer will be understood by referring to the aforementioned description of the electrode mixture of the disclosure.

The substrate is not particularly limited, and may be a negative electrode collector layer, for example, if the negative electrode active material layer comprises the electrode mixture of the disclosure.

### EXAMPLES

### Example 1

### Production of Evaluation Cell

### (Preparation of Electrode Mixture)

Hard carbon (HC) as an electrode active material and diiron trioxide (Fe₂O₃) were mixed in a mass ratio of 0.49:0.01. Specifically, the ratio of the mass of the Fe₂O₃ with respect to the total mass of the HC and Fe₂O₃ was 2 mass %. The obtained mixture was weighed out with polyvinylidene fluoride (PVdF) as a binder to a mass ratio of 95:5 and dispersed in N-methyl-2-pyrrolidone (NMP), and the dispersion was stirred at 2000 rpm for 10 minutes. This produced an electrode mixture slurry.

### (Formation of Electrode Active Material Layer)

A 75 μm bar coater was used to coat the obtained electrode mixture slurry onto an aluminum (Al) current collector foil. The resulting coated film was dried and punched to φ16 mm, and molded with a pressing machine. This formed an electrode active material layer on an Al current collector foil. The electrode active material layer obtained in this manner was used as a negative electrode active material layer.

### (Fabrication of Cell)

A 2032-type coin cell was fabricated using a laminate of an Al current collector foil and electrode active material layer as the working electrode, metal sodium (Na) as the counter electrode, a 25 μm polypropylene/polyethylene/polypropylene (PP/PE/PP) trilayer material as the separator, and 1 M NaPF₆ EC:DMC=1:1 (volume ratio) as the electrolyte solution.

### Evaluation

### Evaluation of Battery Capacity

A charge-discharge test was conducted in an environment of 25° C. with a voltage range of 0.01-1.5 V and a current value of 0.3 C, and the Na intercalation capacity (charge capacity) and Na deintercalation capacity (discharge capacity) of the coin cell were evaluated. The ratio of the discharge capacity with respect to the charge capacity was recorded as the charge-discharge efficiency.

### Examples 2 to 18 and Comparative Examples 1 to 35

Cells for Examples 2 to 18 and Comparative Examples 1 to 35 were fabricated and evaluated in the same manner as Example 1, except that the metal oxide (MO) and the ratio of the mass of the metal oxide to the total mass of the hard carbon and metal oxide (MO/(HC+MO)) were changed as listed in Tables 1 to 3. Comparative Example 1 is an example of an electrode mixture without a metal oxide. The evaluation results for the charge capacity and discharge capacity of each cell, and its charge-discharge efficiency, are shown in Tables 1 to 3.

For the cells of Comparative Example 1 and Examples 1 to 18, the charge-discharge test was conducted under the same conditions as described above, except for using a current value of 0.1 C. The ratio of the discharge capacity at 0.3 C with respect to the discharge capacity at 0.1 C was recorded as the capacity retention, and evaluation results were obtained as shown in Table 1. The evaluation results with a current value of 0.1, corresponding to Comparative Example 1 and Examples 1 to 18, are shown in Table 4 as Comparative Reference Example 1 and Reference Examples 1 to 18.

TABLE 1

| | | | | | Charge- | |
|---|---|---|---|---|---|---|
| | | | Charge | Discharge | discharge | Capacity |
| | | MO/(HC + | capacity | capacity | efficiency | retention |
| | MO | MO)[wt %] | [mAh/g] | [mAh/g] | [%] | [%] |
| Comp. | — | — | 260 | 218 | 83.8 | 0.80 |
| Example 1 | | | | | | |
| Example 1 | Fe₂O₃ | 2 | 308 | 264 | 85.7 | 1.03 |
| Example 2 | Fe₂O₃ | 5 | 308 | 264 | 85.7 | 1.09 |
| Example 3 | TiO | 2 | 308 | 270 | 87.7 | 0.99 |
| Example 4 | TiO | 5 | 296 | 250 | 84.5 | 0.92 |
| Example 5 | TiO₂ | 2 | 276 | 233 | 84.4 | 0.84 |
| Example 6 | TiO₂ | 5 | 315 | 224 | 71.1 | 0.83 |
| Example 7 | MnO | 2 | 297 | 258 | 86.9 | 0.88 |
| Example 8 | MnO | 5 | 262 | 227 | 86.6 | 0.93 |
| Example 9 | Mn₂O₃ | 2 | 289 | 251 | 86.9 | 0.96 |
| Example 10 | Mn₂O₃ | 5 | 284 | 241 | 84.9 | 0.91 |
| Example 11 | MnO₂ | 2 | 262 | 224 | 85.5 | 0.85 |
| Example 12 | MnO₂ | 5 | 254 | 219 | 86.2 | 0.83 |
| Example 13 | ZnO | 2 | 272 | 220 | 80.9 | 0.83 |
| Example 14 | ZnO | 5 | 274 | 219 | 79.9 | 0.85 |
| Example 15 | NiO | 2 | 355 | 224 | 63.1 | 0.96 |
| Example 16 | NiO | 5 | 282 | 219 | 77.7 | 0.98 |
| Example 17 | CuO | 2 | 302 | 230 | 76.2 | 0.87 |
| Example 18 | CuO | 5 | 282 | 226 | 80.1 | 0.87 |

As shown in Table 1, with the batteries of the Examples which each comprised an electrode mixture containing a predetermined amount of a metal oxide composed of a metal element which was a period 4 d-block element, in addition to hard carbon, the battery capacity, and especially the discharge capacity, was improved compared to the battery of Comparative Example 1 which comprised an electrode mixture without such a metal oxide. Particular improvement in charge-discharge efficiency was exhibited by the batteries of the Examples which included iron, titanium or manganese as elements in the metal oxide. Among these, the highest discharge capacities were exhibited by the batteries of the Examples in which the metal oxide was Fe₂O₃, TiO, MnO or Mn₂O₃. The capacity retention was especially high with batteries of the Examples which included iron in the metal oxide.

TABLE 2

| | | | | | Charge- |
|---|---|---|---|---|---|
| | | | Charge | Discharge | discharge |
| | | MO/(HC + | capacity | capacity | efficiency |
| | MO | MO)[wt %] | [mAh/g] | [mAh/g] | [%] |
| Comp. Example 1 | — | — | 260 | 218 | 83.8 |
| Comp. Example 2 | Fe₂O₃ | 10 | 260 | 215 | 82.7 |
| Comp. Example 3 | Fe₂O₃ | 20 | 257 | 213 | 82.9 |
| Comp. Example 4 | TiO | 10 | 245 | 201 | 82.0 |
| Comp. Example 5 | TiO | 20 | 220 | 167 | 75.9 |
| Comp. Example 6 | TiO₂ | 10 | 276 | 205 | 74.3 |
| Comp. Example 7 | TiO₂ | 20 | 237 | 182 | 76.8 |
| Comp. Example 8 | MnO | 10 | 248 | 204 | 82.3 |
| Comp. Example 9 | MnO | 20 | 250 | 201 | 80.4 |
| Comp. Example 10 | Mn₂O₃ | 10 | 269 | 213 | 79.2 |
| Comp. Example 11 | Mn₂O₃ | 20 | 136 | 101 | 74.3 |
| Comp. Example 12 | MnO₂ | 10 | 247 | 201 | 81.4 |
| Comp. Example 13 | MnO₂ | 20 | 243 | 194 | 79.8 |
| Comp. Example 14 | ZnO | 10 | 185 | 126 | 68.1 |
| Comp. Example 15 | ZnO | 20 | 229 | 153 | 66.8 |
| Comp. Example 16 | NiO | 10 | 287 | 215 | 74.9 |
| Comp. Example 17 | NiO | 20 | 164 | 114 | 69.5 |
| Comp. Example 18 | CuO | 10 | 276 | 215 | 77.9 |
| Comp. Example 19 | CuO | 20 | 324 | 213 | 65.7 |

As shown in Table 2, with the batteries of Comparative Examples 2 to 13, wherein MO/(HC+MO) was outside of the range of the present disclosure even though the electrode mixture contained a metal oxide composed of a metal element which was a period 4 d-block element, no improvement in battery capacity, and especially discharge capacity, was seen compared to the battery of Comparative Example 1.

TABLE 3

| | | | | | Charge- |
|---|---|---|---|---|---|
| | | | Charge | Discharge | discharge |
| | | MO/(HC + | capacity | capacity | efficiency |
| | MO | MO)[wt %] | [mAh/g] | [mAh/g] | [%] |
| Comp. Example 1 | — | — | 260 | 218 | 83.8 |
| Comp. Example 20 | Al₂O₃ | 2 | 195 | 147 | 75.4 |
| Comp. Example 21 | Al₂O₃ | 5 | 179 | 140 | 78.2 |
| Comp. Example 22 | Al₂O₃ | 10 | 221 | 181 | 81.9 |
| Comp. Example 23 | Al₂O₃ | 20 | 254 | 204 | 80.3 |
| Comp. Example 24 | SiO₂ | 2 | 224 | 172 | 76.8 |
| Comp. Example 25 | SiO₂ | 5 | 251 | 200 | 79.7 |
| Comp. Example 26 | SiO₂ | 10 | 227 | 176 | 77.5 |
| Comp. Example 27 | SiO₂ | 20 | 327 | 189 | 57.8 |
| Comp. Example 28 | HfO₂ | 2 | 298 | 212 | 71.1 |
| Comp. Example 29 | HfO₂ | 5 | 166 | 120 | 72.3 |
| Comp. Example 30 | HfO₂ | 10 | 165 | 119 | 72.1 |
| Comp. Example 31 | HfO₂ | 20 | 186 | 151 | 81.2 |
| Comp. Example 32 | MgO | 2 | 250 | 200 | 80.0 |
| Comp. Example 33 | MgO | 5 | 241 | 189 | 78.4 |
| Comp. Example 34 | MgO | 10 | 179 | 133 | 74.3 |
| Comp. Example 35 | MgO | 20 | 137 | 92 | 67.2 |

As shown in Table 3, when the electrode mixture contained a metal oxide composed of a metal element which was not a period 4 d-block element, even if MO/(HC+MO) was within the range of the present disclosure, no improvement in battery capacity, and especially discharge capacity, was seen compared to the battery of Comparative Example 1.

TABLE 4

| | | | | | Charge- |
|---|---|---|---|---|---|
| | | | Charge | Discharge | discharge |
| | | MO/(HC + | capacity | capacity | efficiency |
| | MO | MO)[wt %] | [mAh/g] | [mAh/g] | [%] |
| Comp. Reference | — | — | 326 | 273 | 83.7 |
| Example 1 | | | | | |
| Reference Example 1 | Fe₂O₃ | 2 | 383 | 256 | 66.8 |
| Reference Example 2 | Fe₂O₃ | 5 | 355 | 243 | 68.5 |
| Reference Example 3 | TiO | 2 | 311 | 273 | 87.8 |
| Reference Example 4 | TiO | 5 | 314 | 272 | 86.6 |
| Reference Example 5 | TiO₂ | 2 | 311 | 277 | 89.1 |
| Reference Example 6 | TiO₂ | 5 | 318 | 270 | 84.9 |
| Reference Example 7 | MnO | 2 | 323 | 292 | 90.4 |
| Reference Example 8 | MnO | 5 | 275 | 243 | 88.4 |
| Reference Example 9 | Mn₂O₃ | 2 | 354 | 261 | 73.7 |
| Reference Example 10 | Mn₂O₃ | 5 | 313 | 264 | 84.3 |
| Reference Example 11 | MnO₂ | 2 | 302 | 264 | 87.4 |
| Reference Example 12 | MnO₂ | 5 | 306 | 263 | 85.9 |
| Reference Example 13 | ZnO | 2 | 313 | 265 | 84.7 |
| Reference Example 14 | ZnO | 5 | 310 | 259 | 83.5 |
| Reference Example 15 | NiO | 2 | 351 | 234 | 66.7 |
| Reference Example 16 | NiO | 5 | 368 | 224 | 60.9 |
| Reference Example 17 | CuO | 2 | 321 | 264 | 82.2 |
| Reference Example 18 | CuO | 5 | 318 | 260 | 81.8 |

As shown in Table 4, the charge-discharge efficiency at 0.1 C was improved when the metal oxide included titanium or manganese.

### REFERENCE SIGNS LIST

1 Battery
10 Negative electrode collector layer
20 Negative electrode active material layer
30 Electrolyte layer
40 Positive electrode active material layer
50 Positive electrode collector layer

1. An electrode mixture comprising hard carbon,
wherein the electrode mixture comprises a metal oxide,
wherein the metal element constituting the metal oxide is a period 4 d-block element, and
wherein the ratio of the mass of the metal oxide with respect to the total mass of the hard carbon and metal oxide is less than 10 mass %.

2. The electrode mixture according to claim 1, wherein the metal oxide includes at least one element from among iron, titanium, manganese, zinc, nickel and copper.

3. The electrode mixture according to claim 2, wherein the metal oxide is Fe₂O₃, TiO, TiO₂, MnO, Mn₂O₃, MnO₂, NiO, CuO or ZnO.

4. The electrode mixture according to claim 2, wherein the metal oxide includes at least one element from among iron, titanium and manganese.

5. The electrode mixture according to claim 4, wherein the metal oxide is Fe₂O₃, TiO, TiO₂, MnO, Mn₂O₃ or MnO₂.

6. The electrode mixture according to claim 5, wherein the metal oxide is Fe₂O₃, TiO, MnO or Mn₂O₃.

7. The electrode mixture according to claim 4, wherein the metal oxide includes the element iron.

8. The electrode mixture according to claim 7, wherein the metal oxide is Fe₂O₃.

9. A battery, comprising:
a negative electrode collector layer, a negative electrode active material layer, an electrolyte layer, a positive electrode active material layer and a positive electrode collector layer in that order, and
wherein either the negative electrode active material layer or the positive electrode active material layer comprises an electrode mixture according to claim 1.

10. The battery according to claim 9, wherein the negative electrode active material layer comprises the electrode mixture.

11. The battery according to claim 10, wherein the battery is a sodium ion battery with the electrolyte layer comprising sodium ion.
